(19) United States
(12) Patent Application Publication
(10) Pub. No.: US 2026/0285162 A1
(43) Pub. Date: Sep. 24, 2026

(54) VEHICLE CONTROL SYSTEM

(71) Applicant: TOYOTA JIDOSHA KABUSHIKI KAISHA, Toyota-shi (JP)

(72) Inventor: Taisuke YAMADA, Toyota-shi (JP)

(73) Assignee: TOYOTA JIDOSHA KABUSHIKI KAISHA, Toyota-shi (JP)

(21) Appl. No.: 19/439,999

(22) Filed: Jan. 5, 2026

(30) Foreign Application Priority Data
Jan. 29, 2025 (JP) 2025-012796

(51) Int. Cl. B60L 3/00; B60L 1/00; B60L 50/60; B60T 1/06; B60T 1/093

(52) U.S. Cl. CPC B60L 3/0046; B60L 1/003; B60L 3/0076; B60L 3/0092; B60L 50/60; B60T 1/065; B60T 1/093; B60L 2210/10; B60L 2250/26

(57) ABSTRACT

A vehicle control system for controlling a vehicle includes a main power supply device capable of supplying electric power to a plurality of onboard vehicle devices and an auxiliary power supply device including a plurality of batteries and capable of supplying electric power to at least one of the plurality of onboard vehicle devices when the main power supply device is abnormal. The vehicle control system further comprises a vehicle controller configured to control the vehicle based on a remaining power amount of the auxiliary power supply device.

### REFERENCE TO RELATED APPLICATIONS

This application claims priority from Japanese Patent Application No. 2025-12796 filed on Jan. 29, 2025. The entire content of the priority application is incorporated herein by reference.

### TECHNICAL FIELD

The present disclosure relates to a vehicle control system for controlling a vehicle equipped with a power supply device capable of supplying electric power to an onboard vehicle device.

### BACKGROUND ART

Japanese Patent Application Laid-open No. 2019-081461 discloses a vehicle equipped with a power supply device capable of supplying electric power to a brake device as an onboard vehicle device. The brake device disclosed in Japanese Patent Application Laid-open No. 2019-081461 includes a master cylinder as a manual hydraulic pressure source, a wheel cylinder, and a pump device. In the master cylinder, a pressurizing piston is advanced by an advance of a brake pedal, and hydraulic pressure is generated in a hydraulic pressure chamber. A hydraulic chamber of the master cylinder is connected to the wheel cylinder, and the pump device is connected to the wheel cylinder via a solenoid valve.

Moreover, the power supply device described in Japanese Patent Application Laid-open No. 2019-081461 includes a main power supply and a capacitor. In the vehicle described in Japanese Patent Application Laid-open No. 2019-081461, power is also supplied from the capacitor when the amount of power required by the brake device is greater than or equal to a determination threshold relative to the amount of power that can be supplied from the main power supply to the brake device.

### SUMMARY

The object of the present disclosure is to satisfactorily manage the remaining power amount of an auxiliary power supply device in a vehicle including a main power supply device and the auxiliary power supply device.

An aspect of the present disclosure relates to a vehicle control system for controlling a vehicle. The vehicle includes a main power supply device capable of supplying electric power to a plurality of onboard vehicle devices, and an auxiliary power supply device including a plurality of batteries and capable of supplying electric power to at least one of the plurality of onboard vehicle devices when the main power supply device is abnormal. The vehicle control system further comprises a vehicle controller configured to control the vehicle based on a remaining power amount of the auxiliary power supply device.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which;

FIG. 1 is a diagram conceptually showing a supply state of power from a power supply device included in a vehicle controlled by a vehicle control system according to a first embodiment of the present disclosure to an onboard vehicle device;

FIG. 2 is a diagram conceptually showing a supply state other than the above supply state;

FIG. 3 is a diagram conceptually showing the vehicle control system;

FIG. 4 is a diagram conceptually showing a brake device as the onboard vehicle device mounted in the vehicle;

FIG. 5 is a flowchart showing a vehicle control program stored in a storage of the vehicle control system;

FIG. 6 is a flowchart conceptually showing a charge control start program stored in the storage;

FIG. 7 is a diagram conceptually showing a state of power supply from the power supply device to an onboard vehicle device provided in another vehicle;

FIG. 8 is a diagram conceptually showing a brake device mounted in a vehicle other than the vehicle;

FIG. 9 is a diagram conceptually showing a state of power supply from a power supply device other than the power supply device to the brake device shown in FIG. 4; and

FIG. 10 is a diagram conceptually showing a state of power supply from the power supply device shown in FIG. 9 to the brake device shown in FIG. 8.

### DESCRIPTION

Hereinafter, a vehicle control system as an embodiment of the present disclosure will be described with reference to the drawings.

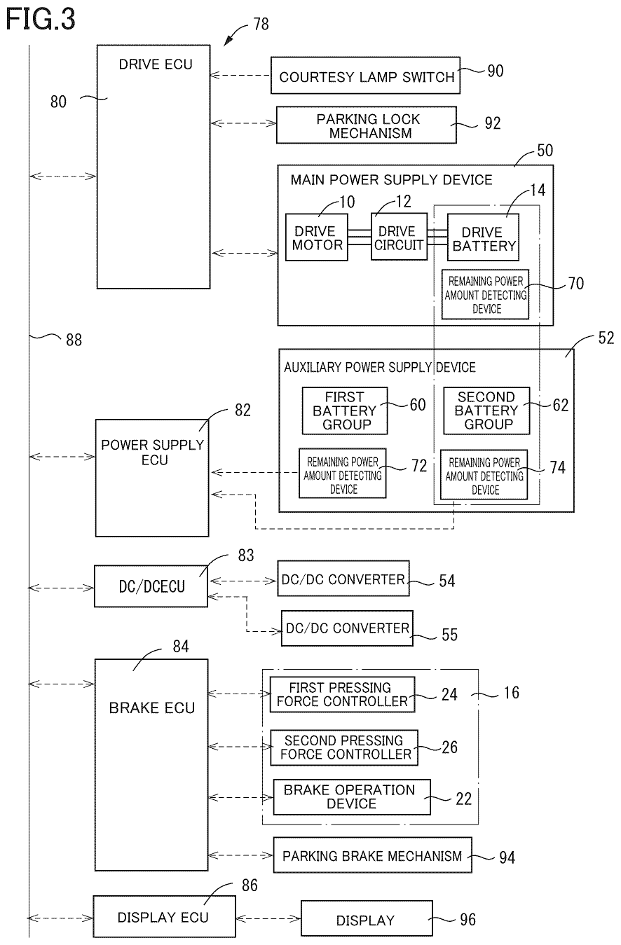

As shown in FIG. 3, a vehicle on which the present vehicle control system is mounted is an electric vehicle or a hybrid vehicle in which a drive device includes a drive motor 10 as an electric motor. The drive motor 10 is connected to a drive battery 14 as a battery via a drive circuit 12 as an inverter. When power is supplied from the drive battery 14 to the drive motor 10, the drive motor 10 is rotationally driven to apply a driving force to a drive wheel as a wheel. When power generated by regenerative braking of the drive motor 10 is charged to the drive battery 14, regenerative braking force is applied to the drive wheel. The drive battery 14 may be, for example, a lithium ion battery.

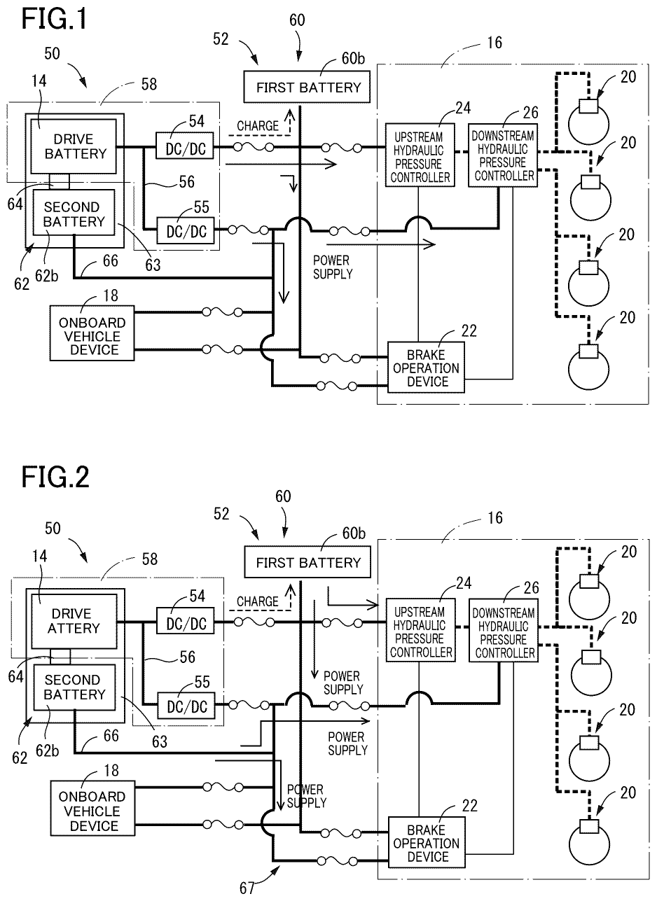

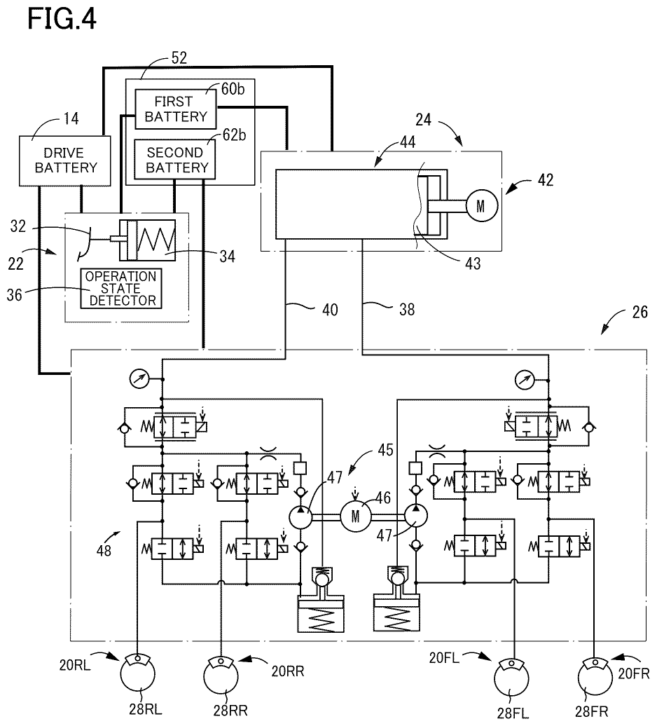

As shown in FIGS. 1-10, the electric power of the drive battery 14 is supplied to a by-wire type brake device 16 and other onboard vehicle device 18 as an onboard vehicle device. As shown in FIG. 4, the brake device 16 includes a plurality of friction brakes 20FL, 20FR, 20RL, 20RR, a brake operation device 22, a first pressing force controller 24, a second pressing force controller 26, and the like. Each of the plurality of friction brakes 20FL, 20FR, 20RL, 20RR is provided corresponding one of a plurality of wheels 28FL, 28FR, 28RL, 28RR provided in the vehicle. Hereinafter, the friction brakes 20FL, 20FR, 20RL, 20RR, and the like are collectively referred to as the friction brakes 20 when they are not required to be distinguished by the wheel position. It is noted that, in the brake device 16, the brake operation device 22 is mechanically separated from the friction brake 20, the first pressing force controller 24, and the second pressing force controller 26.

The friction brake 20 generates a frictional force by pressing a frictional engagement member against a brake rotator rotatable integrally with the wheel 28, thereby suppressing the rotation of the wheel 28. In the present embodiment, the friction brake 20 is a hydraulic brake that presses the frictional engagement member against the brake rotator by a pressing force corresponding to the hydraulic pressure.

The brake operation device 22 includes a brake pedal 32, a stroke simulator 34, an operation state detector 36 and the like. The brake pedal 32 is an example of a brake operating member operable by a driver. The stroke simulator 34 generates a reaction force corresponding to an operation force applied to the brake pedal 32 by the driver and applies the reaction force to the brake pedal 32. The operation state detector 36 detects an operation state of the brake pedal 32 by the driver. The operation state of the brake pedal 32 can be expressed by an operation force or an operation stroke applied to the brake pedal 32 by the driver.

Each of the first pressing force controller 24 and the second pressing force controller 26 applies a pressing force to the friction brake 20 and controls the pressing force. In the present embodiment, each of the first pressing force controller 24 and the second pressing force controller 26 includes a hydraulic pressure generator for generating hydraulic pressure by the supply of electric power, and can control the hydraulic pressure generated in the hydraulic pressure generator. The hydraulic pressure generated and controlled by the first pressing force controller 24 and the second pressing force controller 26 is supplied to the friction brake 20. The brake operation device 22 is not connected to each of the first pressing force controller 24 and the second pressing force controller 26 through liquid passages.

The friction brake 20 is connected to the first pressing force controller 24 via liquid passages 38 and 40, and the second pressing force controller 26 is provided in the middle of the liquid passages 38 and 40. Therefore, the first pressing force controller 24 can be referred to as an upstream hydraulic pressure control, and the second pressing force controller 26 can be referred to as a downstream hydraulic pressure control.

As shown in FIG. 4, the upstream hydraulic pressure controller 24 includes, for example, an electric cylinder device 44 which moves a pressurizing piston 43 forward by an electric actuator 42 to generate hydraulic pressure. The hydraulic pressure of the electric cylinder device 44 is controlled by the electric actuator 42. In the present embodiment, the electric cylinder device 44 corresponds to the hydraulic pressure generator.

The downstream hydraulic pressure controller 26 includes, for example, a pump device 45 and a solenoid valve device 48. The pump device 45 is an example of the hydraulic pressure generator and includes an electric motor 46 and a pump 47. The solenoid valve device 48 includes a plurality of solenoid valves and the like, and can individually control the hydraulic pressure of each of the friction brakes 20.

As shown in FIG. 1, a main power supply device 50 and an auxiliary power supply device 52 are connected to the brake device 16, and power is supplied to the brake device 16 from the main power supply device 50 and the auxiliary power supply device 52. The main power supply device 50 and the auxiliary power supply device 52 are independent of each other, and power of the auxiliary power supply device 52 is supplied to the brake device 16 and the like when the main power supply device 50 is abnormal or the like.

The main power supply device 50 includes the drive motor 10, the drive circuit 12, the drive battery 14, DC/DC converters 54, 55, and the like. A power supply line 56 is connected to the drive battery 14, and the DC/DC converters 54, 55 are provided on the power supply line 56. In the present embodiment, the drive battery 14, the DC/DC converters 54, 55, the power supply line 56, and the like constitute a power supply unit 58.

The DC/DC converters 54, 55 lower the voltage of the drive battery 14. The DC/DC converters 54 and 55 can, for example, lower the voltage of the drive battery 14 to a voltage used in the brake device 16 or the onboard vehicle device 18. The power of the voltage lowered by the DC/DC converters 54 and 55 is supplied to the brake device 16 and the like. The main power supply device 50 is connected to the upstream hydraulic pressure controller 24, the downstream hydraulic pressure controller 26, the brake operation device 22 and the like.

The auxiliary power supply device (the sub power supply device) 52 includes a first battery group 60 and a second battery group 62. Each of the first battery group 60 and the second battery group 62 includes one or more batteries. Each of the one or more batteries included in the first battery group 60 is referred to as a first battery 60b. Each of the one or more batteries included in the second battery group 62 is referred to as a second battery 62b.

All of the one or more first batteries 60b are connected to the first pressing force controller (upstream hydraulic pressure controller) 24 and to the brake operation device 22. All of the one or more second batteries 62b are connected to the downstream hydraulic pressure controller 26 and to the brake operation device 22. Moreover, the first battery 60b is charged by the electric power of the drive battery 14.

It is noted that, in the present embodiment, the electric power of the main power supply device 50 and the auxiliary power supply device 52 is supplied to the onboard vehicle device 18 and the like in addition to the brake device 16. However, since the onboard vehicle device 18 is not related to the main disclosure, a detailed description thereof will be omitted. For simplicity, the first battery group 60 and the first battery 60b are used synonymously, and the second battery group 62 and the second battery 62b are used synonymously.

In the present embodiment, the drive battery 14 and the second battery 62b are provided in the same unit. For example, an assembly (module) of a plurality of cells belonging to the drive battery 14 and an assembly (module) including a plurality of cells belonging to the second battery 62b are provided in one unit 63.

In the unit 63, the cells belonging to the drive battery 14 are provided exclusively for the drive battery, and the cells belonging to the second battery 62b are provided exclusively for the second battery. A power supply line 66 other than the power supply line 56 is connected to the second battery 62b.

Moreover, the number of the cells dedicated to the second battery, which are the cells belonging to the second battery 62b, arranged in series is smaller than the number of the cells dedicated to the drive battery, which are the cells belonging to the drive battery 14, arranged in series. Therefore, the output voltage of the second battery 62b is lower than the output voltage of the drive battery 14. For example, the output voltage of the drive battery 14 can be 200~300 V, and the output voltage of the second battery 62 b can be 10~50 V. Power can be supplied from the second battery 62b to the brake device 16 or the like without passing through a DC/DC converter.

On the other hand, a switch 64 as a switcher is provided between the drive battery 14 and the second battery 62b. The switch 64 electrically connects or separates the drive battery 14 and the second battery 62b.

The switch 64 connects the drive battery 14 and the second battery 62b at the time of charging. Regenerative power generated when the drive motor 10 operates as a generator is supplied to both the drive battery 14 and the second battery 62b to be charged.

The switch 64 separates the drive battery 14 and the second battery 62b at the time of discharging. When power is supplied from the main power supply device 50 to the brake device 16 or the like, the power stored in the dedicated cell for the second battery belonging to the second battery 62b is not supplied. When power is supplied from the second battery 62b to the brake device 16 or the like, the power stored in the dedicated cell for the drive battery belonging to the drive battery 14 is not supplied. As described above, the drive battery 14 and the second battery 62b can be considered to be independent of each other.

In the present embodiment, a remaining power amount of the drive battery 14 is detected by a remaining power amount detecting device 70, and a remaining power amount of the second battery 62b is detected by a remaining power amount detecting device 74. Moreover, a remaining power amount of the first battery 60b is detected by a remaining power amount detecting device 72. It is noted that each of the remaining power amount detecting devices 70, 72, and 74 detects the corresponding remaining power amount of an aggregate of the plurality of cells based on the remaining power amount of each of the plurality of cells.

Hereinafter, In the present embodiment, the sum Σq1 (n) of the remaining power amount q1 (1) of each of the first batteries 60b included in the first battery group 60 may be referred to as “the remaining power amount Q1 of the first battery group 60”, and the sum Σq2 (n) of the remaining power amount q2 (1) of each of the second batteries 62b included in the second battery group 62 may be referred to as “the remaining power amount Q2 of the second battery group 62”. The sum of the remaining power amount Q1 of the first battery group 60 and the remaining power amount Q2 of the second battery group 62 may be referred to as “a total remaining power amount QS of the auxiliary power supply device 52”.

Σq1(n)=Q1

Σq2(n)=Q2

Q1+Q2=QS

The present vehicle control system is provided with a controller 78 mainly composed of a computer. The controller 78 includes a drive ECU (Electronic Control Unit) 80, a power supply ECU 82, a DC/DC ECU 83, a brake ECU 84, a display ECU 86, and the like. These devices are communicatively connected via a CAN (Controller Area Network) 88.

The drive ECU 80 controls the drive motor 10 or the like as a drive source of the vehicle. The drive motor 10 controls a drive force applied to the vehicle, thereby controlling the acceleration of the vehicle or controlling the traveling speed of the vehicle. The drive motor 10 is connected to the drive ECU 80 via the drive circuit 12, and a courtesy lamp switch 90, a parking lock mechanism 92, and the like are also connected to the drive ECU 80.

The courtesy lamp switch 90 is a switch which is switched from OFF to ON when the door of the vehicle is switched from closed to open. When the driver gets on the vehicle and moves the vehicle, the drive ECU 80 is often switched from OFF to ON after the courtesy lamp switch 90 is switched from OFF to ON. The parking lock mechanism 92 locks the rotation of the output shaft of the drive transmission device which transmits the output of the drive source to the wheels, or releases the lock to permit the rotation of the output shaft.

The power supply ECU 82 controls the charging of the first battery 60b of the first battery group 60 and creates information (command) related to a vehicle control based on the remaining power of the auxiliary power supply device 52. The remaining power amount detecting devices 72 and 74 are connected to the power supply ECU 82.

It is noted that the remaining power amount of the auxiliary power supply device 52 corresponds to the total remaining power amount of the auxiliary power supply device 52 (the sum of the remaining power amount of the plurality of batteries), the remaining power amount of either the first battery group 60 or the second battery group 62, and the like.

The DC/DC ECU 83 controls the DC/DC converters 54 and 55.

The brake ECU 84 controls the first pressing force controller 24 and the second pressing force controller 26 based on the operation state of the brake pedal (the brake operating member) 32 to control the pressing force of the friction brake 20. The operation state detector 36 is connected to the brake ECU 84, and the electric actuator 42 of the first pressing force controller 24, the pump device 45 of the second pressing force controller 26, the solenoid valve device 48, and the like are also connected to the brake ECU 84. Aa parking brake mechanism 94 is also connected to the brake ECU 84. In the parking brake mechanism 94, the parking brake is operated or released by an electric actuator (not shown).

The display ECU 86 controls a display 96 provided in the vehicle. Various kinds of information are displayed on the display 96. The display 96 also includes a head-up display (HUD).

An ECU, not shown, for controlling the onboard vehicle device 18 or the like is also connected to the CAN88 in addition to the drive ECU 80, the power supply ECU 82, the DC/DC ECU 83, the brake ECU 84, the display ECU 86, and the like.

In the vehicle on which the vehicle control system constructed as described above is mounted, as shown in FIG. 1, when the main power supply device 50 is normal, power from the main power supply device 50 is supplied to the brake device 16 (the upstream hydraulic control, the downstream hydraulic control 26, the brake operation device 22) or the like.

On the other hand, when the main power supply device 50 is abnormal, power from the auxiliary power supply device 52 is supplied to the brake device 16 or the like as shown in FIG. 2. The abnormality of the main power supply device 50 is a state in which power cannot be supplied from the main power supply device 50 to the brake device 16 or the like, for example, an abnormality of the power supply unit 58. The abnormality of the power supply unit 58 includes, for example, abnormality of the DC/DC converters 54 and 55 and disconnection of the power supply line 56.

On the other hand, the brake device 16 is a by-wire type, and the friction brake 20 is separated from the brake operation device 22 (the brake operating member 32). Moreover, the friction brake 20 is actuated by the supply of hydraulic pressure generated by the supply of electric power to the upstream hydraulic pressure controller 24 and/or the downstream hydraulic pressure controller 26.

Therefore, when the main power supply device 50 is abnormal, the electric power of the auxiliary power supply device 52 is supplied to the brake device 16 and the like. However, when the remaining power amount of the auxiliary power supply device 52 is small, there may be a case in which the required electric power, which is the electric power required by the brake device 16, is not supplied from the auxiliary power supply device 52 to the brake device 16, and there may be a case in which it is difficult to operate the friction brake 20 satisfactorily.

On the other hand, in the brake device disclosed in Japanese Patent Application Laid-open No. 2019-081461, the hydraulic pressure chamber of the master cylinder is connected to the wheel cylinders via solenoid valves. Each of the solenoid valves is a normally open valve. Therefore, even if power is not supplied to the brake device, hydraulic pressure is generated in the master cylinder when the brake pedal is operated, and the hydraulic brake can be operated. Accordingly, in the brake device described in Japanese Patent Application Laid-open No. 2019-081461, the problem of insufficient remaining power amount of the sub-power supply device does not occur.

Therefore, in the present embodiment, the remaining power amount in the auxiliary power supply device 52 is managed, and even if the main power supply device 50 is normal, the vehicle is restricted when the remaining power amount in the auxiliary power supply device 52 is small.

For example, when the total remaining power amount QS (=Q1+Q2) of the auxiliary power supply device 52, which is the sum of the remaining power amount Q1 (=Σq1(n)) of the first battery group 60 and the remaining power amount Q2 (=Σq2(n)) of the second battery group 62, is small, the speed limit of the vehicle can be lower than when the total remaining power amount QS is strong. As a result, the required electric power in the brake device 16 can be reduced, and when the main power supply device 50 is abnormal, the power consumption in the auxiliary power supply device 52 can be reduced.

Further, when there is a possibility that the total remaining power amount QS of the auxiliary power supply device 52 cannot satisfy the required electric power in the brake device 16, the display 96 can display that the charge amount of the auxiliary battery, which is at least one of the plurality of batteries included in the auxiliary power supply device 52, is small. Moreover, the display 96 can display several indications to urge the driver to stop the vehicle.

Further, when the remaining power amount of the auxiliary power supply device 52 is small, at least one of the parking lock mechanism 92 and the parking brake mechanism 94 (hereinafter, it may be referred to as P-lock) can be automatically activated when the vehicle stops. In addition, the release of the P lock can be prohibited until the remaining power amount of the auxiliary battery is recovered. As a result, the deterioration of the safety of the vehicle can be suppressed.

It should be noted that, in order to easily convey the contents in short words to the driver, terms different from those used in the embodiment may be displayed on the display 96.

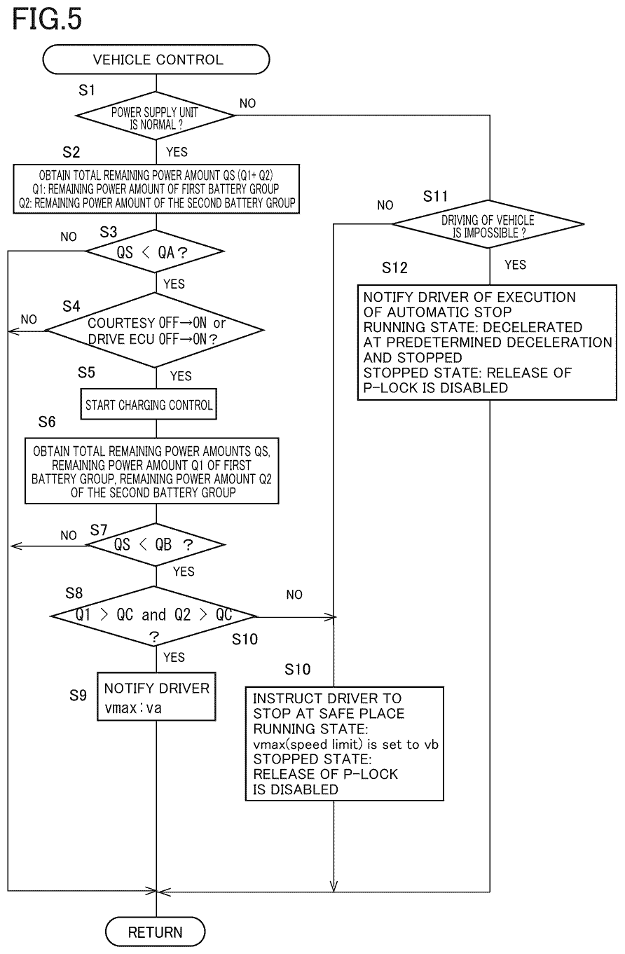

In the present embodiment, a vehicle control program shown in the flowchart of FIG. 5 is executed in the power supply ECU 82. The present program is executed at every predetermined time interval.

In step 1(hereinafter, it is abbreviated as S1, the same shall apply to other steps), it is determined whether or not the power supply unit 58 is normal. When the determination in S1 is YES, in step S2, the remaining power amounts Q1 and Q2 of the first battery group 60 and the second battery group 62 are obtained by the remaining power amount detecting devices 72 and 74, respectively, and the sum QS (Q1+Q2) of these amounts is obtained. In step S3, it is determined whether or not the obtained total remaining power amount QS of the auxiliary power supply device 52 is smaller than a threshold value QA, which is a third set amount. When the determination in step S3 is NO, it is determined that the auxiliary power supply device 52 is sufficiently charged, and step S4 and subsequent steps are not executed.

For example, the threshold value QA can be set based on the required electric power amount of the brake device 16. Specifically, the threshold value QA can be set based on a maximum value, an average value, or the like of the required electric power amount. The required electric power amount is a value determined based on the weight of the vehicle, the braking efficiency, the structure of the brake device 16, and the like, and is preferably determined for each vehicle.

When the power of the auxiliary power supply device 52 is supplied to a plurality of onboard vehicle devices, it is desirable that the threshold value QA is set based on the sum of the required electric power amounts of each of the plurality of onboard vehicle devices.

Further, the threshold value QA can be set to the remaining power amount that is considered preferable to charge the auxiliary power supply device 52. Generally, a charging control is usually performed so that the remaining power amount of the battery is within a set range. Therefore, for example, the charging control can be started when the sum of the remaining power amounts of the first battery group 60 and the second battery group 62 becomes smaller than the amount determined based on the sum of the lower limits of the set ranges of the remaining power amounts of the first battery 60b and the second battery 62b.

When the determination in step S3 is YES, it is determined in step S4 whether the courtesy lamp switch 90 has been switched from OFF to ON or whether the drive ECU 80 has been switched from OFF to ON. When the determination is YES, the charging control is started in step S5. The start of the charging control will be described later.

In step S6, the remaining power amounts Q1 and Q2 of the first battery group 60 and the second battery group 62 are obtained by the remaining power amount detecting devices 72 and 74, and the total remaining power amount QS of the auxiliary power supply device 52 is obtained. In step S7, it is determined whether or not the total remaining power amount QS of the auxiliary power supply device 52 is smaller than a threshold value QB which is a first set amount. When the determination in step S7 is YES, in step S8, it is determined whether or not each of the remaining power amounts Q1 and Q2 of the first battery group 60 and the second battery group 62 is larger than a threshold value QC which is a second set amount.

Q1>QC and Q2>QC

The threshold value QB is smaller than the threshold value QA. Similarly to the threshold value QA, the threshold value QB can be set to an amount that can satisfy the required electric power amounts of one or more onboard vehicle devices connected to the auxiliary power supply device 52. For example, the threshold value QA can be set based on the sum of the maximum required electric power amounts of one or more onboard vehicle devices, and the threshold value QB can be set based on the sum of the average required electric power amounts of the one or more onboard vehicle devices. Further, the threshold value QA can be set to an amount obtained by adding a margin amount ΔQx to the sum of the required electric power amounts, and the threshold value QB can be set to an amount obtained by adding a margin amount ΔQy smaller than the margin amount ΔQx to the sum of the required electric power amounts.

Further, the threshold value QB may be an amount that is considered to be insufficient in charge amount due to, for example, a short charging control time. For example, it may be a value smaller than the threshold value QA or a value obtained by multiplying the threshold value QA by a set ratio smaller than 1.

Further, the threshold value QB may be a value determined based on the sum of amounts each smaller by a set amount than the upper limit of the set range of the remaining power amount for each of the first battery 60b and the second battery 62b.

The threshold value QC is a value smaller than the threshold value QB and can be set based on, for example, the required electric power amount in each of the upstream hydraulic pressure controller 24 and the downstream hydraulic pressure controller 26. For example, when power cannot be supplied from one of the first battery group 60 and the second battery group 62, a braking force is applied to the vehicle by the other of the upstream hydraulic pressure controller 24 and the downstream hydraulic pressure controller 26. The threshold value QC can be set based on the required electric power amount in the other of the upstream hydraulic pressure controller 24 and the downstream hydraulic pressure controller 26.

When power from the first battery group 60 and the second battery group 62 is supplied to a plurality of onboard vehicle devices, the threshold value QB and QC may be set based on an amount obtained by adding the required electric power amounts in the respective onboard vehicle devices.

When the determination in step S8 is YES, in step S9, the driver is notified that the charge is insufficient, and the speed limit is set to va. The content of the notification is supplied to the display ECU 86, and the speed limit va is supplied to the drive ECU 80.

Specifically, “There is nothing wrong with the system, but the auxiliary battery is not fully charged, so the vehicle speed will be restricted to va until the auxiliary battery has sufficient power. After charging is completed, it will be notified and the vehicle speed limit will be released.” can be displayed on the display 96. The speed limit va can be set to, for example, 80~100 km/h, which is a speed that does not interfere with normal traveling. In this case, the vehicle's driving speed is restricted.

When the determination in step S8 is NO, in step S10, the driver is instructed to stop at a safe place, and the speed limit is set to vb lower than va. In addition, when the vehicle stops, the P lock is automatically actuated to lock the vehicle. At least one of the P lock cannot be released until the determination in step S8 is YES. The instruction is supplied to the drive ECU 80 and the brake ECU 84. In this case, it can be considered that the release of the P-lock is restricted.

Specifically, the following contents can be displayed on the display 96. “There is nothing wrong with the system. However, the auxiliary battery charge is extremely low, which may interfere with driving. Stop and wait in a safe place. The vehicle speed is temporarily restricted to vb until sufficient power is stored in the auxiliary battery. After stopping, the P-lock is engaged and cannot be released. After charging is completed, it will be notified and the vehicle speed limit will be released.” Further, the speed limit vb can be set to 20-30 km/h for the purpose of urging the driver to stop.

In steps 9 and 10, it is considered that the charging control of the first battery 60 b is continuously performed by the power of the main power supply device 50.

When the determination in step S1 is NO, it is determined in step S11 whether or not the driving of the vehicle itself is impossible. When the determination in step S11 is NO, step S10 is executed. However, when the determination in step S1 and step S11 is NO and step S10 is executed, it is considered that the first battery 60b is not charged by the power of the main power supply device 50.

If the determination in step S11 is YES, in step S12, in a case where the vehicle is running, the vehicle is decelerated at a predetermined deceleration and stopped. In a case where the vehicle is stopped, the P-lock is actuated and the release of the P-lock is disabled. In this case, it can be assumed that the running (or operation) of the vehicle itself is restricted.

For example, “Due to a system failure, the vehicle cannot be driven. Please stop and wait in a safe place.” can be displayed on the display 96.

As described above, in the present embodiment, the vehicle control is performed based on the remaining power amount of the auxiliary power supply device 52. As a result, the remaining power amount of the auxiliary power supply device 52 can be appropriately managed. For example, it is possible to prevent the remaining power amount of the auxiliary power supply device 52 from becoming smaller than the required electric power amount of the brake device 16 or the like. As a result, even if the brake device 16 is of the by-wire type and power cannot be supplied from the main power supply device 50 to the brake device 16 or the like, the brake device 16 can be operated satisfactorily.

Further, since the auxiliary power supply device 52 includes the plurality of batteries 60b and 62b, even if one of the plurality of batteries 60b and 62b fails, power can be supplied to the brake device 16 or the like. Similarly, even if either the first battery group 60 or the second battery group 62 fails, power can be supplied to the brake device 16. As a result, the fail-safe property can be improved as compared with a case in which the auxiliary power supply device 52 includes only one battery.

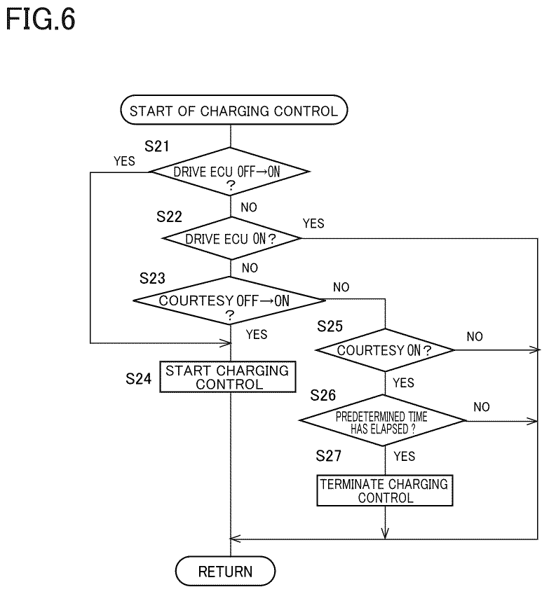

The charging control is started by executing a charging control start program shown in the flowchart of FIG. 6. In step S21, it is determined whether the drive ECU 80 has been switched from OFF to ON, and in step S22, it is determined whether the drive ECU 80 is in the ON state. When both of the determinations in steps S21 and step S22 are NO, in step S23, it is determined whether the courtesy lamp switch 90 has been switched from OFF to ON. Even when the determinations in steps S21 and step S22 are NO, when the determination in step S23 is YES, in step S24, the charging control is started. The DC/DC ECU 83 is switched from OFF to ON, and the DC/DC converters 54 and 55 are turned ON. An instruction is output from the power supply ECU 82 to the DC/DC ECU 83. When the determination in step S21 is YES, step S24 is executed. In a case in which the DC/DC ECU 83 is also turned ON in response to the situation in which the drive ECU 80 becomes ON, there is not much need to output the instruction from the power supply ECU 82 to the DC/DC ECU 83.

On the other hand, when the determination in step S23 is NO, it is determined in step S25 whether the courtesy lamp switch 90 is ON. When the determination is YES, it is determined in step S26 whether the elapsed time after the courtesy lamp switch 90 is turned ON from OFF reaches a set time. When the determination is YES, the charging control is terminated in step S27, and the DC/DC ECU 83 is switched from ON to OFF. When the drive ECU 80 is not turned ON before the set time has passed even when the courtesy lamp switch 90 is turned ON, the charging control is terminated.

As described above, by charging the auxiliary power supply device 52 from an early stage earlier than the time at which the drive ECU 80 become ON, the remaining power amount of the auxiliary power supply device 52 can be increased more favorably.

In the present embodiment, the remaining power amount detecting devices 72 and 74, the power supply ECU 82, the drive ECU 80, the brake ECU 84, the display ECU 86, and the like constitute a vehicle controller. Moreover, the power supply ECU 82 includes a portion for storing the charging control start program shown in the flowchart of FIG. 6, a portion for executing the program, the DC/DC ECU 83, and the like constitute a charging control starter.

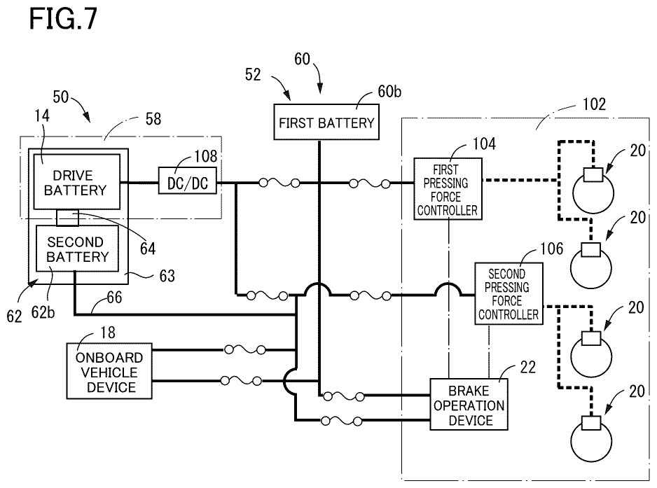

It should be noted that the structure of the brake device is not restricted. For example, a brake device 102 may be of a two-system type. As shown in FIG. 7, in the brake device 102, the friction brakes 20 provided on the front, rear, left, and right wheels 28 are divided into two groups. A first pressing force controller 104 and a second pressing force controller 106 are respectively connected to the two friction brakes 20 belonging to each group. Each of the first pressing force controller 104 and the second pressing force controller 106 may include a pump device and a solenoid valve device, or may include an electric cylinder device.

In the present embodiment, the drive battery 14 and the first battery group 60 are connected to the first pressing force controller 104, and the drive battery 14 and the second battery group 62 are connected to the second pressing force controller 106.

In addition, in the embodiment described above, the drive battery 14 is connected to the upstream pressing force controller 24, which is the first pressing force controller, via the DC/DC converter 54, and the drive battery 14 is connected to the downstream pressing force controller 26, which is the second pressing force controller, via the DC/DC converter 55. In contrast, in the present embodiment, the drive battery 14 is connected to both the first pressing force controller 104 and the second pressing force controller 106 via a common DC/DC converter 108. Thus, it is not necessarily necessary to provide DC/DC converters respectively corresponding to the first pressing force controller 104 and the second pressing force controller 106, but it is possible to provide the only one DC/DC converter 108 in common with them. By reducing the number of DC/DC converters, the cost can be reduced accordingly.

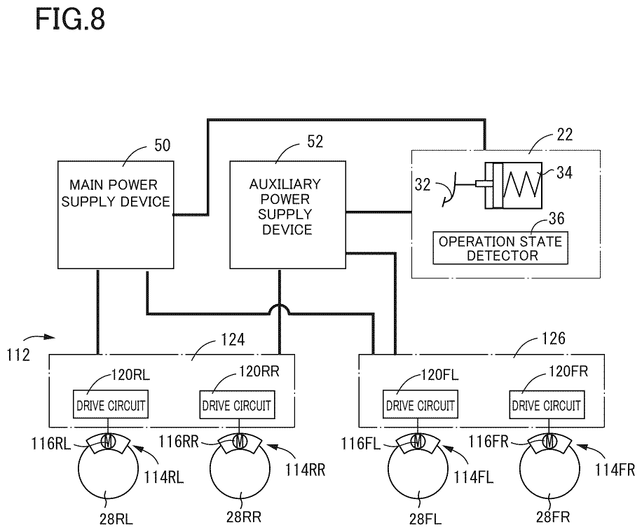

Moreover, as shown in FIG. 8, a brake device 112 can include an electric friction brake 114 as a friction brake. In the electric friction brake 114, the friction engaging member is pressed against the brake rotor by the pressing force output from an electric actuator 116. Further, In the present embodiment, a first pressing force controller 124 is constituted by drive circuits 120FL, 120FR and the like for controlling the supply current to electric actuators 116FL, 116FR of electric friction brakes 114FL, 114FR provided on the right and left front wheels 28FL, 28FR. A second pressing force controller 126 is constituted by drive circuits 120RL, 120RR and the like for electric actuators 116RL, 116RR of electric brakes 114RL, 114RR provided on the right and left rear wheels 28RL, 28RR.

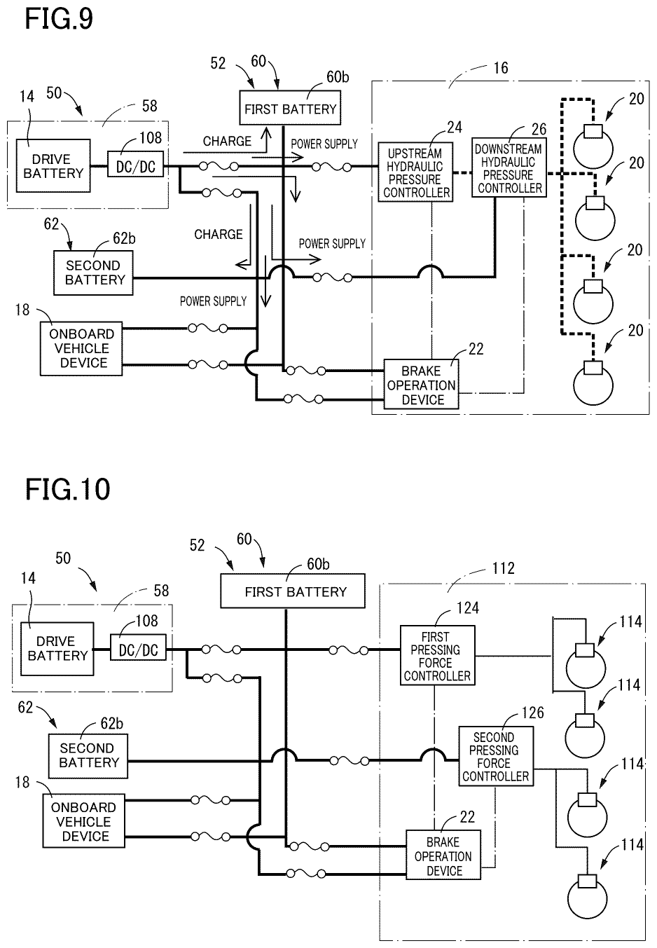

Further, it is not essential that the drive battery 14 and the second battery 62b are provided in the same unit. For example, as shown in FIGS. 9 and 10, the drive battery 14 and the second battery 62b may be provided in separate units. In the present embodiment, the power of the drive battery 14 is dropped by the DC/DC converter 108 to charge the second battery 62b.

Further, the brake device may be applied to an automobile capable of autonomous driving. In an automatic brake device which is a brake device in an automobile capable of autonomous driving, the brake operation device 22 is not indispensable. Even in a case in which the brake operation device 22 is not provided, the automatic brake device may be referred to as a by-wire type brake device in a broad sense.

In the automatic brake device, the first pressing force controller 24, the second pressing force controller 26, and the like may be controlled based on, for example, a relative positional relationship between the own vehicle, which is the present vehicle, and an object located in the vicinity. The relative positional relationship between the own vehicle and surrounding objects is obtained by a surrounding environment obtaining device including a camera, a radar or the like. The present disclosure is also effective in an automobile capable of automatic operation including the main power supply device 50 and the auxiliary power supply device 52.

Further, in the above embodiments, the controller 78 includes the drive ECU 80, the power supply ECU 82, the DC/DC ECU 83, the brake ECU 84, the display ECU 86 and the like, but the structure of the controller 78 does not matter. For example, in the controller 78, the drive ECU 80 and the brake ECU 84 may be provided with the function of the power supply ECU 82. Further, the power supply ECU 82, the drive ECU 80, the brake ECU 84 and the like may be combined into a single ECU, and the drive motor 10, the main power supply device 50, the auxiliary power supply device 52, the brake device 16 and the like may be controlled by the single ECU.

Moreover, in addition to the above embodiments, the present disclosure may be embodied in various forms with various modifications and improvements based on the knowledge of a person skilled in the art.

The following description constitutes claimable inventions.

(1) A vehicle control system for controlling a vehicle, the vehicle comprising a main power supply device capable of supplying electric power to a plurality of onboard vehicle devices, and an auxiliary power supply device including a plurality of batteries and capable of supplying electric power to at least one of the plurality of onboard vehicle devices when the main power supply device is abnormal, and wherein the vehicle control system includes a vehicle controller configured to control the vehicle based on a remaining power amount of the auxiliary power supply device.

The plurality of batteries can be classified into a plurality of battery groups. Each of the plurality of battery groups includes one or more batteries. Each of one or more batteries included in one of the plurality of battery groups supplies power to the same onboard vehicle device. That is, each of one or more batteries included in one of the plurality of battery groups supplies power to the same target.

Preferably, the plurality of batteries included in the auxiliary power supply device are provided independently of the main power supply device. Preferably, the plurality of battery groups are also provided independently of each other.

The onboard vehicle devices to which electric power can be supplied from the auxiliary power supply device may be all of the plurality of onboard vehicle devices to which electric power is supplied by the main power supply device or at least one of the plurality of onboard vehicle devices.

The vehicle controller may control the vehicle so that the amount of electric power consumed by the onboard vehicle devices is reduced or control so that the safety of the vehicle is improved. Moreover, the vehicle controller may control the onboard vehicle device to be supplied which is the onboard vehicle device to which electric power is supplied from the auxiliary power supply device or may control the onboard vehicle device not to be supplied from the auxiliary power supply device.

(2) The vehicle control system according to (1), wherein the vehicle controller is configured to control the vehicle so that when the remaining power amount of the auxiliary power supply device is smaller than a first set amount, restriction applied to the vehicle is stronger than when the remaining power amount of the auxiliary power supply device is equal to or larger than the first set amount, the first set amount being a set amount of the remaining power amount of the auxiliary power supply device.

The restriction of the vehicle includes, for example, a restriction of the temperature of the air conditioner, a restriction of the running speed and acceleration, a restriction of the steering speed, and the like. The strong restriction means that when the air conditioner is used for heating, the upper limit temperature is lowered, and when it is used for cooling, the lower limit temperature is raised. Moreover, the strong restriction means that the restriction of the running speed of the vehicle is lowered, the restriction of the acceleration is reduced, and the restriction of the steering speed is lowered.

(3) The vehicle control system according to (1) or (2), wherein the auxiliary power supply device includes a plurality of battery groups, wherein each of the plurality of battery groups includes one or more of the plurality of batteries, and wherein the vehicle controller is configured to control the vehicle so that when a total remaining power amount of the plurality of batteries is smaller than a first set amount and a remaining power amount of at least one of the plurality of battery groups is equal to or smaller than a second set amount which is less than the first set amount, a speed limit of the vehicle is lower than when the total remaining power amount of the plurality of batteries is smaller than the first set amount and the remaining power amount of each of the plurality of battery groups is larger than the second set amount, each of the first set amount and the second set amount being a set amount of the remaining power amount of the auxiliary power supply device.

The remaining power amount of the battery group refers to the sum of the remaining power amounts of each of the one or more batteries included in the battery group.

(4) The vehicle control system according to any one of (1) to (3), wherein the auxiliary power supply device includes a plurality of battery groups, wherein each of the plurality of battery groups includes one or more of the plurality of batteries, and wherein the vehicle controller is configured to control the vehicle so as to give a driver different notifications between (a) a case where a total remaining power amount of the plurality of batteries is smaller than a first set amount and a remaining power amount of at least one of the plurality of battery groups is equal to or smaller than a second set amount which is less than the first set amount and (b) a case where the total remaining power amount of the plurality of batteries is smaller than the first set amount and the remaining power amount of each of the plurality of battery groups is larger than the second set amount, each of the first set amount and the second set amount being a set amount of the remaining power amount of the auxiliary power supply device.

In the present embodiment, the notifications outputted by the notification device provided in the vehicle are changed based on the remaining power amount of the auxiliary power supply device. The notification device may be a display, but is not restricted to a display.

(5) The vehicle control system according to any one of (1) to (4), wherein the auxiliary power supply device includes a plurality of battery groups, wherein each of the plurality of battery groups includes one or more of the plurality of batteries, and wherein, when a total remaining power amount of the plurality of batteries is smaller than a first set amount and a remaining power amount of at least one of the plurality of battery groups is equal to or smaller than a second set amount which is less than the first set amount, the vehicle controller is configured to automatically actuate at least one of a parking lock mechanism and a parking brake mechanism in a state in which the vehicle is in a stopped state, each of the first set amount and the second set amount being a set amount of the remaining power amount of the auxiliary power supply device.

(6) The vehicle control system according to any one of (1) to (5), wherein the auxiliary power supply device includes a plurality of battery groups, wherein each of the plurality of battery groups includes one or more of the plurality of batteries, and wherein, when a total remaining power amount of the plurality of batteries is smaller than a first set amount and a remaining power amount of at least one of the plurality of battery groups is equal to or smaller than a second set amount which is less than the first set amount, the vehicle controller is configured to maintain a locked state until the remaining power amount of each of the plurality of battery groups becomes larger than the second set amount in a state in which at least one of a parking lock mechanism and a parking brake mechanism is in the locked state and the vehicle is a stopped state, each of the first set amount and the second set amount being a set amount of the remaining power amount of the auxiliary power supply device.

When the at least one of the parking lock and the parking brake is in the locked state, release of the locked state is prohibited until the remaining power amount of each of the plurality of batteries becomes larger than the second set amount.

(7) The vehicle control system according to any one of (1) to (6), further comprising a charging control starter configured to start, when a total remaining power amount of the plurality of batteries is smaller than a third set amount, a charging control for the auxiliary power supply device in response to switching of a door of the vehicle from a closed state to an open state, the third set amount being a set amount of the remaining power amount of the auxiliary power supply device.

The third set amount may be larger than the first set amount.

(8) The vehicle control system according any one of (1) to (7), wherein at least one battery included in the main power supply device and at least one of the plurality of batteries of the auxiliary power supply device are provided in the same unit.

In this mode, the battery is an aggregate (module) of a plurality of cells. The module included in the main power supply and at least one of the plurality of modules included in the auxiliary power supply device are provided in the same unit (packaged).

(9) The vehicle control system according to any one of (1) to (8), wherein the main power supply device includes a lithium ion battery and at least one of the plurality of batteries in the auxiliary power supply device is a lithium ion battery.

In a case where a lithium ion battery is used, the remaining power amount can be satisfactorily detected.

(10) The vehicle control system according to any one of (1) to (9), wherein the plurality of onboard vehicle devices includes a brake device in which a brake operating member and one or more friction brakes are mechanically separated.

(11) The vehicle control system according to any one of (1) to (9), wherein the plurality of onboard vehicle devices includes an automatic brake device for automatically operating one or more friction brakes based on the surrounding environment around the vehicle.

The automatic brake device can be considered to be a by-wire type brake device in a broad sense.

(12) The vehicle control system according to any one of (1) to (10), wherein the brake device includes a brake operation device including the brake operation member operable by the driver and operation state detector configured to detect an operation state of the brake operation member, a plurality of friction brakes each provided for a corresponding one of a plurality of wheels of the vehicle and each configured to press a friction engagement member against a brake rotor integrally rotatable with the corresponding one of the plurality wheels so as to generate a friction force, and a pressing force controller configured to, in each of the plurality of friction brakes, apply a pressing force and control the pressing force based on the operation state of the brake operation member detected by the operation state detector, the pressing force being a force generated by pressing the friction engagement member against the brake rotor, wherein the brake operation device and each of the plurality of friction brakes are mechanically separated from each other and the brake operation device and the pressing force controller are mechanically separated from each other, and wherein all of the plurality of batteries of the auxiliary power supply device are connected to the brake operation device.

The friction brake may be a hydraulic pressure brake or an electric friction brake.

(13) The vehicle control system according to any one of (1) to (12), wherein the brake device includes two system-brakes, wherein the brake device includes a plurality of friction brakes each provided for a corresponding one of a plurality of wheels of the vehicle and each configured to press a friction engagement member against a brake rotor integrally rotatable with the corresponding one of the plurality wheels so as to generate a friction force, a first pressing force controller configured to apply a first pressing force to one or more of a plurality of first friction brakes of the plurality of friction brakes and to be capable of controlling the first pressing force, the plurality of the first friction brakes belonging to a first system-brake of the two system-brakes, and a second pressing force controller configured to apply a second pressing force to one or more of a plurality of second friction brakes of the plurality of friction brakes and to be capable of controlling the second pressing force, the plurality of second friction brakes belonging to a second system-brake of the two system-brakes, the one or more of the plurality of second friction brakes being other than the one or more of the plurality of first friction brakes, wherein the auxiliary power supply device includes a first battery group composed of one or more of the plurality of batteries, and a second battery group composed of one or more of the plurality of batteries, the one or more batteries belonging to the second battery group being other than the one or more batteries belonging to the first battery group, and wherein the first battery group is connected to the first pressing force controller and the second battery group is connected to the second pressing force controller.

(14) The vehicle control system according to any one of (1) to (12), wherein the brake device includes a plurality of hydraulic pressure brakes each provided for a corresponding one of a plurality of wheels of the vehicle and each configured to press a friction engagement member against a brake rotor integrally rotatable with the corresponding one of the plurality wheels, an upstream hydraulic pressure controller configured to be capable of commonly controlling hydraulic pressures of the plurality of hydraulic pressure brakes, a downstream hydraulic pressure controller configured to be capable of individually controlling hydraulic pressures of the plurality of hydraulic pressure brakes, wherein the auxiliary power supply device includes a first battery group composed of one or more of the plurality of batteries, and a second battery group composed of one or more of the plurality of batteries, the one or more batteries belonging to the second battery group being other than the one or more batteries belonging to the first battery group, and wherein the first battery group is connected to the upstream hydraulic pressure controller and the second battery group is connected to the downstream hydraulic pressure controller.

What is claimed is

1. A vehicle control system for controlling a vehicle,
the vehicle comprising:
a main power supply device capable of supplying electric power to a plurality of onboard vehicle devices, and
an auxiliary power supply device including a plurality of batteries and capable of supplying electric power to at least one of the plurality of onboard vehicle devices when the main power supply device is abnormal, and
wherein the vehicle control system further comprises a vehicle controller configured to control the vehicle based on a remaining power amount of the auxiliary power supply device.

2. The vehicle control system according to claim 1,
wherein the vehicle controller is configured to control the vehicle so that when the remaining power amount of the auxiliary power supply device is smaller than a first set amount, restriction applied to the vehicle is stronger than when the remaining power amount of the auxiliary power supply device is equal to or larger than the first set amount, the first set amount being a set amount of the remaining power amount of the auxiliary power supply device.

3. The vehicle control system according to claim 1,
wherein the auxiliary power supply device includes a plurality of battery groups,
wherein each of the plurality of battery groups includes one or more of the plurality of batteries, and
wherein the vehicle controller is configured to control the vehicle so that when a total remaining power amount of the plurality of batteries of the auxiliary power supply device is smaller than a first set amount and a remaining power amount of at least one of the plurality of battery groups is equal to or smaller than a second set amount which is less than the first set amount, a speed limit of the vehicle is lower than when the total remaining power amount of the plurality of batteries is smaller than the first set amount and the remaining power amount of each of the plurality of battery groups is larger than the second set amount, each of the first set amount and the second set amount being a set amount of the remaining power amount of the auxiliary power supply device.

4. The vehicle control system according to claim 1,
wherein the auxiliary power supply device includes a plurality of battery groups,
wherein each of the plurality of battery groups includes one or more of the plurality of batteries, and
wherein the vehicle controller is configured to control the vehicle so as to give a driver different notifications between (a) a case where a total remaining power amount of the plurality of batteries of the auxiliary power supply device is smaller than a first set amount and a remaining power amount of at least one of the plurality of battery groups is equal to or smaller than a second set amount which is less than the first set amount and (b) a case where the total remaining power amount of the plurality of batteries is smaller than the first set amount and the remaining power amount of each of the plurality of battery groups is larger than the second set amount, each of the first set amount and the second set amount being a set amount of the remaining power amount of the auxiliary power supply device.

5. The vehicle control system according to claim 1,
wherein the auxiliary power supply device includes a plurality of battery groups,
wherein each of the plurality of battery groups includes one or more of the plurality of batteries, and
wherein, when a total remaining power amount of the plurality of batteries of the auxiliary power supply device is smaller than a first set amount and a remaining power amount of at least one of the plurality of battery groups is equal to or smaller than a second set amount which is less than the first set amount, the vehicle controller is configured to automatically cause at least one of a parking lock mechanism and a parking brake mechanism to be a locked state and maintain the locked state until the remaining power amount of each of the plurality of battery groups becomes larger than the second set amount in a state in which the vehicle is in a stopped state, each of the first set amount and the second set amount being a set amount of the remaining power amount of the auxiliary power supply device.

6. The vehicle control system according to claim 1, further comprising a charging control starter configured to start, when a total remaining power amount of the plurality of batteries is smaller than a third set amount, a charging control for the auxiliary power supply device in response to switching of a door of the vehicle from a closed state to an open state, the third set amount being a set amount of the remaining power amount of the auxiliary power supply device.

7. The vehicle control system according to claim 1,
wherein at least one battery included in the main power supply device and at least one of the plurality of batteries of the auxiliary power supply device are provided in the same unit.

8. The vehicle control system according to claim 1, further comprising (a) a by wire type brake device including at least one friction brake separated from a brake operation member operable by a driver, or (b) a brake device configured to automatically actuate the at least one friction brake based on the surrounding environment around the vehicle.

9. The vehicle control system according to claim 8,
wherein the brake device includes:
a brake operation device including the brake operation member operable by the driver and an operation state detector configured to detect an operation state of the brake operation member,
a plurality of friction brakes each provided for a corresponding one of a plurality of wheels of the vehicle and each configured to press a friction engagement member against a brake rotor integrally rotatable with the corresponding one of the plurality wheels so as to generate a friction force, and
a pressing force controller configured to, in each of the plurality of friction brakes, apply a pressing force and control the pressing force based on the operation state of the brake operation member detected by the operation state detector, the pressing force being a force generated by pressing the friction engagement member against the brake rotor,
wherein the brake operation device and each of the plurality of friction brakes are mechanically separated from each other, and the brake operation device and the pressing force controller are mechanically separated from each other, and
wherein all of the plurality of batteries of the auxiliary power supply device are connected to the brake operation device.

10. The vehicle control system according to claim 8,
wherein the brake device is a brake system including two system-brakes,
wherein the brake device includes:
a plurality of friction brakes each provided for a corresponding one of a plurality of wheels of the vehicle and each configured to press a friction engagement member against a brake rotor integrally rotatable with the corresponding one of the plurality wheels so as to generate a friction force,
a first pressing force controller configured to apply a first pressing force to one or more of a plurality of first friction brakes of the plurality of friction brakes and to be capable of controlling the first pressing force, the plurality of the first friction brakes belonging to a first system-brake of the two system-brakes, and
a second pressing force controller configured to apply a second pressing force to one or more of a plurality of second friction brakes of the plurality of friction brakes and to be capable of controlling the second pressing force, the plurality of second friction brakes belonging to a second system-brake of the two system-brakes, the one or more of the plurality of second friction brakes being other than the one or more of the plurality of first friction brakes,
wherein the auxiliary power supply device includes:
a first battery group including one or more of the plurality of batteries, and
a second battery group including one or more of the plurality of batteries, the one or more batteries belonging to the second battery group being other than the one or more batteries belonging to the first battery group, and
wherein the first battery group is connected to the first pressing force controller and the second battery group is connected to the second pressing force controller.

11. The vehicle control system according to claim 8,
wherein the brake device includes:
a plurality of hydraulic pressure brakes each provided for a corresponding one of a plurality of wheels of the vehicle and each configured to press a friction engagement member against a brake rotor integrally rotatable with the corresponding one of the plurality wheels so as to suppress rotation of the corresponding one of plurality of wheels,
an upstream hydraulic pressure controller configured to be capable of commonly controlling hydraulic pressures of the plurality of hydraulic pressure brakes,
a downstream hydraulic pressure controller configured to be capable of individually controlling hydraulic pressure of each of the plurality of hydraulic pressure brakes,
wherein the auxiliary power supply device includes:
a first battery group composed of one or more of the plurality of batteries, and
a second battery group composed of one or more of the plurality of batteries, the one or more batteries belonging to the second battery group being other than the one or more batteries belonging to the first battery group, and
wherein the first battery group is connected to the upstream hydraulic pressure controller and the second battery group is connected to the downstream hydraulic pressure controller.
